(19) United States
(12) Patent Application Publication
(10) Pub. No.: US 2021/0319253 A1
(43) Pub. Date: Oct. 14, 2021

(54) Device adn method for generating saliency map of a picture

(71) Applicants: XIAODONG GU, BEIJING (CN); GUOPING QIU, NOTTINGHAM (GB); ZHIBO CHEN, BEIJING (CN); QUQING CHEN, BEIJING (CN); CHARLES CHUANMING WANG, BEIJING (CN)

(72) Inventors: XIAODONG GU, BEIJING (CN); GUOPING QIU, NOTTINGHAM (GB); ZHIBO CHEN, BEIJING (CN); QUQING CHEN, BEIJING (CN); CHARLES CHUANMING WANG, BEIJING (CN)

(21) Appl. No.: 12/311,715

(22) PCT Filed: Oct. 10, 2006
(86) PCT No.: PCT/CN2006/002643

§ 371 Date: Jun. 26, 2012

(51) Int. Cl. G06K 9/46; G06K 9/00

(52) U.S. Cl. CPC G06K 9/4671; G06K 9/4642; G06K 9/00711

(57) ABSTRACT

The invention relates to a method for generating a saliency map for a picture of a sequence of pictures, the picture being divided in blocks of pixels. The method comprises a step for computing a saliency value for each block of the picture. According to the invention, the saliency value equals the self information of the block, the self information depending on the spatial and temporal contexts of the block.

### 1. FIELD OF THE INVENTION

The invention relates to a method and a device for generating a saliency map for a picture of a sequence of pictures.

### 2. BACKGROUND OF THE INVENTION

Salient visual features that attract human attention can be important and powerful cues for video analysis and processing including content-based coding, compression, transmission/rate control, indexing, browsing, display and presentation. State of art methods for detecting and extracting visually salient features mainly handle still pictures. The few methods that handle sequences of pictures first compute spatial and temporal saliency values independently and then combine them in some rather arbitrary manners in order to generate a spatio-temporal saliency value. The spatial saliency values are generally based on the computation, in some heuristic ways, of the contrasts of various visual features (intensity, color, texture, etc.). These methods often assume that temporal saliency value relates to motion. Therefore, they first estimate motion fields using state of art motion estimation methods and then compute the temporal saliency values as some heuristically chosen functions of the estimated motion fields.

These methods have many drawbacks. First, accurate estimation of motion fields is known to be a difficult task. Second, even with accurate motion fields, the relationship between these motion fields and temporal saliency values is not straightforward. Therefore, it is difficult to compute accurate temporal saliency values based on estimated motion fields. Third, assuming spatial and temporal saliency values can be correctly computed, the combination of these values is not straightforward. State-of-art methods often weight temporal and spatial saliency values in an arbitrary manner to get a global value of spatio-temporal saliency value which is often not accurate.

### 3. SUMMARY OF THE INVENTION

The object of the invention is to resolve at least one of the drawbacks of the prior art. The invention relates to a method for generating a saliency map for a picture of a sequence of pictures, the picture being divided in blocks of pixels. The method comprises a step for computing a saliency value for each block of the picture. According to the invention, the saliency value equals the self information of the block, the self information depending on the spatial and temporal contexts of the block.

Preferentially, the self information is computed based on the probability of observing the block given its spatial and temporal contexts, the probability being the product of the probability of observing the block given its spatial context and of the probability of observing the block given its temporal context.

According to one preferred embodiment, the probability of observing the block given its spatial context is estimated as follows :

associate to each block of the picture a set of K ordered coefficients, with K a positive integer, the set of coefficients being generated by transforming the block by a first predefined transform;

estimate, for each coefficient of order k, its probability distribution within the image, k ε [1; K]); and

compute the probability of observing the block given its spatial context as the product of the probabilities of each coefficient of the set associated to the block.

Preferentially, the first predefined transform is a two-dimensional discrete cosine transform.

Advantageously, the probability of observing the block given its temporal context is estimated based on the probability of observing a first volume comprising blocks co-located to the block in the N pictures preceding the picture where the block is located, called current picture, and on the probability of observing a second volume comprising the first volume and the block, with N a positive integer. Preferentially, the probability of observing the first volume is estimated as follows :

associate a set of P ordered coefficients to each volume comprising the blocks co-located to one of the block of the current picture in the N pictures preceding the current picture, with P a positive integer, the set of coefficients being generated by transforming the volume by a second predefined transform;

estimate, for each coefficient of order p, its probability distribution, p ε [1; P]; and

compute the probability of observing the first volume as the product of the probabilities of each coefficient of the set associated to the first volume.

Preferentially, the probability of observing the second volume is estimated as follows :

associate a set of Q ordered coefficients to each volume comprising one of the block of the current picture and the blocks co-located to the block in the N pictures preceding the current picture, with Q a positive integer, the set of coefficients being generated by transforming the volume by the second predefined transform;

estimate, for each coefficient of order q, its probability distribution, q ε[1; Q]; and

compute the probability of observing the second volume as the product of the probabilities of each coefficient of the set associated to the second volume.

Advantageously, the second predefined transform is a three-dimensional discrete cosine transform.

The invention also relates to a device for generating a saliency map for a picture of a sequence of pictures, the picture being divided in blocks of pixels, comprising means for computing a saliency value for each block of the picture characterized in that saliency value equals the self information of the block, the self information depending on the spatial and temporal contexts of the block.

The invention also concerns a computer program product comprising program code instructions for the execution of the steps of the method of saliency maps computation as described above, when the the program is executed on a computer.

### 4. BRIEF DESCRIPTION OF THE DRAWINGS

Other features and advantages of the invention will appear with the following description of some of its embodiments, this description being made in connection with the drawings in which:

FIG. 1 depicts a sequence of pictures divided into blocks of pixels;

FIG. 2 depicts a flowchart of the method according to the invention;

FIG. 3 depicts a block diagram of a device for generating saliency maps according to the invention;

FIG. 4 depicts a picture of a sequence of pictures;

FIG. 5 depicts a spatio-temporal saliency map of the picture depicted on FIG. 4;

FIG. 6 depicts a temporal saliency map of the picture depicted on FIG. 4; and

FIG. 7 depicts a spatial saliency map of the picture depicted on FIG. 4.

### 5. DETAILED DESCRIPTION OF PREFERRED EMBODIMENTS

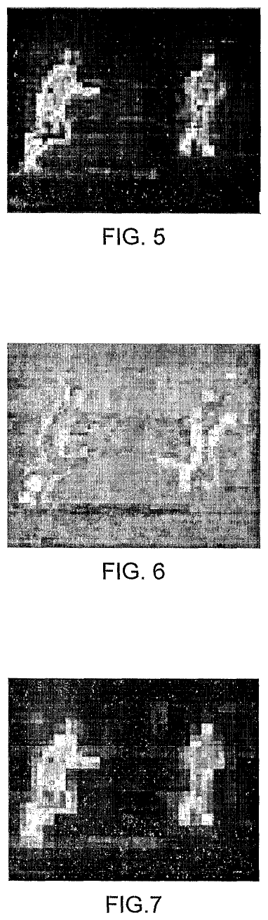

The method according to the invention consists in generating a spatio-temporal saliency map as depicted on FIG. 5 for a picture depicted on FIG. 4 of a sequence of pictures. A saliency map is defined as a two-dimensional topographic representation of conspicuity. To this aim, the invention consists in computing a spatio-temporal saliency value for each block of pixels of the picture.

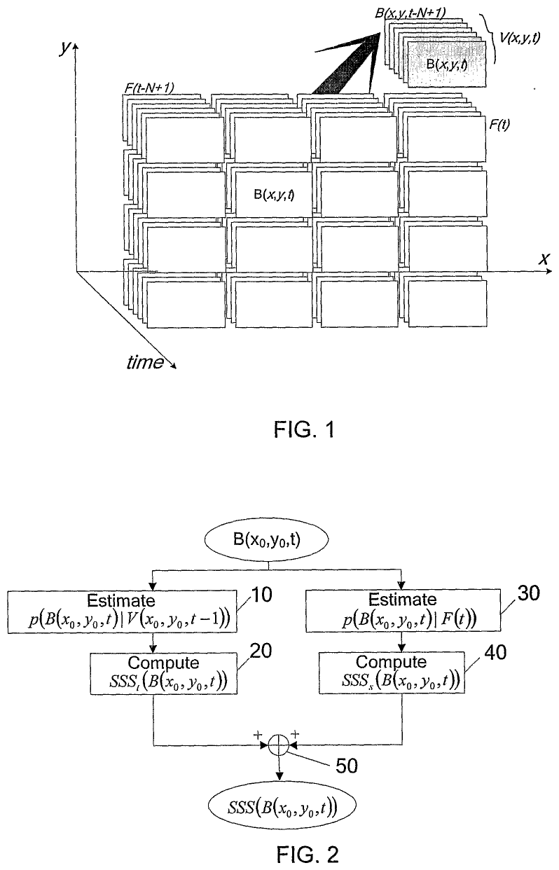

In reference to FIG. 1, the pictures F(t) of the sequence are divided in blocks of pixels, t being a temporal reference. Each block B(x, y, t) of n by m pixels is called a spatio-temporal event. The event B(x, y, t) is thus a block of pixels located at spatial coordinates (x, y) in the picture F(t). The N co-located blocks from pictures F(t), F(t−1), F(t−N+1), i.e. the blocks located at the same spatial position (x, y) as B(x, y, t), form a spatio-temporal volume denoted V(x, y, t), where N is a predefined positive integer. A value of 2 frames for N is a good compromise between the accuracy and the complexity of the model. V(x, y, t) records how the block located at (x,y) evolves over time.

The uniqueness of a spatio-temporal event B(x, y, t) is affected by its spatial and temporal contexts. If an event is unique in the spatial context, it is likely that it is salient. Similarly, if it is unique in the temporal context it is also likely to be salient. Both the spatial context and the temporal context influence the uniqueness of a spatio-temporal event. Therefore, according to a first embodiment, a spatio-temporal saliency value ss8(B(x₀,_{y0},0) is computed for a given block of pixels B(x₀, Y₀, t) in a picture F(t) as the amount of self information Iₛₜ(B(x₀,_{y0}, t) contained in the event B(x₀, y₀, t) given its spatial and temporal contexts. The self information iₛᵢ(B(x₀, y₀, t)) represents the amount of information gained when one learns that B(x₀, Y₀, t) has occurred. According to the Shannon's information theory, the amount of self information Iₛₜ(B(x₀,y₀,t) is defined as a positive and decreasing function f of the probability of occurrence, i.e. Iₛₜ(B(x₀, y₀,t))=f (p(B(x₀, y₀,t)|V(x₀, y₀, t−1),F(t))), with f(1)=0, f(0)=infinity, and f(P(x)*P(y))=f(P(x))+f(P(y)) if x and y are two independent events. f is defined as follows: f(x)=log(1/x). According to the Shannon's information theory, the self information I(x) of an event x is thus inversely proportional to the likelihood of observing x.

The spatio-temporal saliency value SSS(B(x₀, y₀,t) associated to the block B(x₀,y₀,t) is therefore defined as follows: SSS(B(x₀, y₀,t))=Iₛₜ(B(x₀, y₀,t))=log(*(x₀, y₀,t−1), F(t))). The spatial context of the event B(x₀, Y₀,t) is the picture F(t). The temporal context of the event B(x₀, y₀, t) is the volume _{V}(_{xo,} ^{yo,} t-1), i.e. the set of blocks co-located with the block B(x₀, Y₀, t) and located in the N pictures preceding the picture F(t). A block in a picture F(t′) is co-located with the block B(x₀, y₀, t) if it is located in F(t′) at the same position (x₀, y₀) as the block B(x₀, y₀, t) in the picture F(t).

In order to simplify the computation of the saliency values, the spatial and temporal conditions are assumed to be independent. Therefore, the joint conditional probability p(B(x₀, y₀,t)|V(x₀, y₀,t−1), F(t)) may be rewritten as follows:

p(B(x₀, y₀, t)|V(x₀, y₀, t−1), F(t))=p(B(x₀, y₀t−1))*p(B(x₀, y₀, t)|F(t))

Therefore according to a preferred embodiment depicted on FIG. 2, the spatio-temporal saliency value associated to a given block B(x₀, y₀, t) is computed as follows:

SSS(B(x₀, y₀, t))=−log(p(B(x₀y₀, t)|V(x₀y₀, t−1)))−log(p(B(x₀, y₀, t)|F(t)))

In FIG. 2, the represented boxes are purely functional entities, which do not necessarily correspond to physical separated entities. Namely, they could be developed in the form of software, or be implemented in one or several integrated circuits. Let SSS, (B(x₀, y₀, t))=−log(p(B(x₀, y₀,t)|V(x₀, y₀, t−1))) and SSSₛ(B(x₀, y₀, t))=−log(p(B(x₀, y₀,t)|F(t))). Advantageously, the two conditional probabilities p(B(x₀, y₀, t)|V(x₀, y₀, t−1)) and p(B(x₀, y₀, t)|F(t)) of the spatio-temporal event B(x₀, y₀, t) are estimated independently. Unlike previous methods, where the spatial and temporal saliency values are computed independently and then combined together in some arbitrary ways, in the invention the decomposition is natural and derived from the joint spatio-temporal saliency value. It therefore provides more meaningful saliency maps. Besides, by assuming independency of spatial and temporal conditions, spatio-temporal saliency value computation of the event B(x₀, Y₀, t) is faster and enables for real time processing.

The temporal conditional probability p(B(x₀, y₀, t)|V(x₀, y₀, t−1)) is estimated 10 from the probabilities of the volumes V(x₀,y₀,t) and V(x₀, y₀, t−1). Indeed,

$$p ( B ( {x}_{0} , {y}_{0} , t ) \vert V ( {x}_{0} , {y}_{0} , t - 1 ) ) = \frac{p ( B ( {x}_{0} , {y}_{0} , t ) , V ( {x}_{0} , {y}_{0} , t - 1 ) )}{p ( V ( {x}_{0} , {y}_{0} , t - 1 ) )} = \frac{p ( V ( {x}_{0} , {y}_{0} , t ) )}{p ( V ( {x}_{0} , {y}_{0} , t - 1 ) )}$$

(eq1). For the purpose of estimating the probabilities p(V(x₀, y₀, t)) and p(V(x₀, y₀, y−1)), the high dimensional data set V(x,y,t) is projected into an uncorrelated vector space. For example, if N=2, m=n=4, then V(x,y,t) ε R³², i.e. to a 32 dimensional vector space. Let ϕₖ, k=1, 2, . . . K, be a K orthogonal transform vector space basis. If V(x,y,t) ε R³², then K=32. The spatio-temporal probability p(V(x₀, y₀,t)) is thus estimated as follows:
Step 1: for each position (x,y), compute the coefficients cₖ(x,y,t) of V(x,y,t) in the vector space basis as follows: cₖ (x, y, t)=ϕₖV(x,y,t) ∀x,y;
Step 2: estimate the probability distribution pₖ(c) of cₖ(x,y,t); and
Step 3: compute the probability p(V(x₀, y₀, t)) as follows:

p(V(x₀, y₀, t))=Πₖpₖ(ϕₖV(x₀, y₀, t)).

The same method is used to estimate the probability p(V(x₀, y₀, t−1)).

The temporal saliency value SSS,(B(x₀, y₀, t)) is then computed 20 from p(V(x₀, y₀, t)) and p(V(x₀, y₀, t−1) according to (eq1). A temporal saliency map is depicted on FIG. 6.

The method described above for estimating the probability p(V(x₀, y₀, t)) is used to estimate 30 the probability p(B(x₀, y₀, t)). The spatial conditional probability p(B(x₀, y₀, t)|F(t)) is equivalent to p(B(x₀, y₀t)) since only the current frame F(t) influence the uniqueness of a spatio-temporal event B(x₀, y₀, t). Therefore, to estimate p(B(x₀, y₀, t)|F(t)) it is only required to estimate the probability of the spatio-temporal event B(x₀, y₀, t) against all the events in the picture F(t) as follows:

Step 1: for each position (x,y), compute the coefficients dₖ(x,_{y},t) of B(x,y,t) in the vector space basis as follows: dₖ(x,y,t)=ϕₖB(x,y,t) ∀x,y;
Step 2: estimate the probability distribution of dₖ(x,y,t), pₖ(d); and
Step 3: compute the probability p(B(x₀, y₀, t)) as follows:

p(B(x₀, y₀, t))=Πₖpₖ(ϕₖB(x₀, y₀t))

Preferentially, a 2D-DCT (discrete cosine transform) is used to compute the probability p(B(x₀, y₀, t)) . Each 4×4 blocks B(x,y,t) in a current picture F(t) is transformed (step 1) in a 16-D vector (d₀(x,y,t), d₁(x,y,t), . . . , dₖ(x,y,t)). The probability distribution pₖ(d) is estimated (step 2) within the picture by computing an histogram in each dimension k. Finally, the multiple probability p(B(x₀y₀, t)) is derived (step 3) based on these estimated distributions as the product of the probabilities pₖ(ϕₖB(x₀, y₀, t)) of each coefficient dₖ(x,y,t). The same method is applied to compute the probabilities p(V(x₀,y₀,t)) and p(V(x₀,y₀,t−1)). However, in this case a 3D DCT is applied instead of a 2D DCT, The method therefore enables for real time processing at a rate of more than 30 pictures per second for CIF format pictures. Besides, since the model is based on information theory, it is more meaningful than state of art methods based on statistics and heuristics. For example, if the spatio-temporal saliency value of one block is 1 and the spatio-temporal saliency value of another block is 2, then the first block is about twice important than the second one in the same situation. This conclusion cannot be drawn with spatio-temporal saliency maps derived with state of art methods.

The spatial saliency value SSSₛ(B(x₀, y₀, t)) is then computed 40 from the probability p(B(x₀, y₀,t) as follows: SSSₛ(B(x₀, y₀,t))=−log(p(B(x₀, y₀t))). A spatial saliency map is depicted on FIG. 7.

The global saliency value SSSₛ(B(x₀, y₀, t) is finally computed 50 as the sum of the temporal and spatial saliency values.

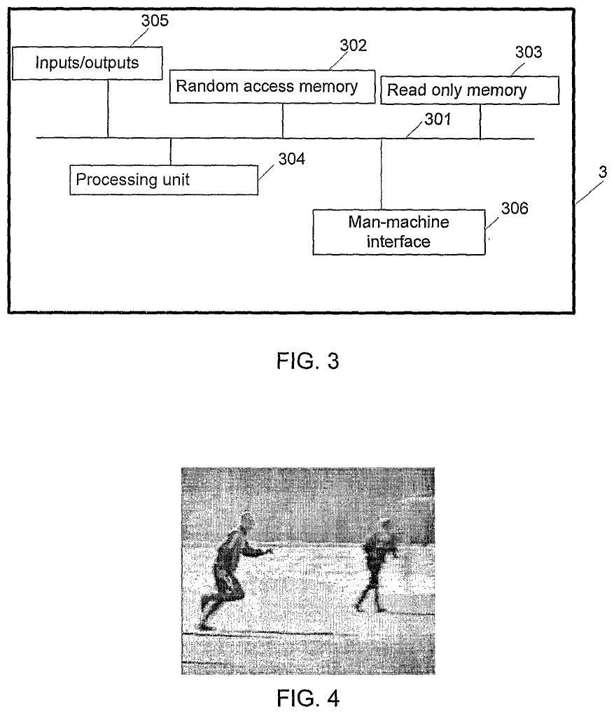

In reference to FIG. 3, the invention also relates to a device 3 implementing the method described previously. Only the essential elements of the device 3 are represented in FIG. 3. The device 3 comprises in particular: a random access memory 302 (RAM or similar component), a read only memory 303 (hard disk or similar component), a processing unit 304 such as a microprocessor or a similar component, an input/output interface 305 and a man-machine interface 306. These elements are linked together by an address and data bus 301. The read only memory 303 contains the algorithms implementing steps 10 to 50 of the method according to the invention. On power-up, the processing unit 304 loads and executes the instructions of these algorithms. The random access memory 302 in particular comprises the programmes for operating the processing unit 304 which are loaded on power-up of the appliance, as well as the pictures to be processed. The inputs/outputs interface 305 has the function of receiving the input signal (i.e. the sequence of pictures) and outputs the saliency maps generated according to steps 10 to 50 of the method of the invention. The man-machine interface 306 of the device allows the operator to interrupt the processing. The saliency maps computed for a picture is stored in random access memory then transferred to read only memory so as to be archived with a view to subsequent processing. The man-machine interface 306 in particular comprises a control panel and a display screen.

The saliency maps generated for the picture of a sequence of pictures can advantageously help video processing and analysis including content-based coding, compression, transmission/rate control, picture indexing, browsing, display and video quality estimation.

1. Method for generating a saliency map for a picture of a sequence of pictures, said picture being divided in blocks of pixels, comprising a step for computing a saliency value for each block of said picture wherein the saliency value equals the self information of said block, said self information depending on the spatial and temporal contexts of said block.

2. Method of claim 1, wherein said self information is computed based on the probability of observing said block given its spatial and temporal contexts, said probability being the product of the probability of observing said block given its spatial context and of the probability of observing said block given its temporal context.

3. Method of claim 2, wherein the probability of observing said block given its spatial context is estimated as follows :
associate to each block of said picture a set of K ordered coefficients, with K a positive integer, said set of coefficients being generated by transforming said block by a first predefined transform;
estimate, for each coefficient of order k, its probability distribution within said image, k ε [1; K]; and
compute the probability of observing said block given its spatial context as the product of the probabilities of each coefficient of the set associated to said block.

4. Method of claim 3, wherein said first predefined transform is a two-dimensional discrete cosine transform.

5. Method of claim 2, wherein the probability of observing said block given its temporal context is estimated based on the probability of observing a first volume comprising blocks co-located to said block in the N pictures preceding the picture where said block is located, called current picture, and on the probability of observing a second volume comprising said first volume and said block, with N a positive integer.

6. Method of claim 5, wherein the probability of observing said first volume is estimated as follows :
associate a set of P ordered coefficients to each volume comprising the blocks co-located to one of the block of said current picture in the N pictures preceding said current picture, with P a positive integer, said set of coefficients being generated by transforming said volume by a second predefined transform;
estimate, for each coefficient of order p, its probability distribution, p ε [1; P]; and
compute the probability of observing said first volume as the product of the probabilities of each coefficient of the set associated to said first volume.

7. Method of claim 5, wherein the probability of observing said second volume is estimated as follows:
associate a set of Q ordered coefficients to each volume comprising one of the block of said current picture and the blocks co-located to said block in the N pictures preceding said current picture, with Q a positive integer, said set of coefficients being generated by transforming said volume by said second predefined transform;
estimate, for each coefficient of order q, its probability distribution, q ε [1; Q]; and
compute the probability of observing said second volume as the product of the probabilities of each coefficient of the set associated to said second volume.

8. Method of claim 6, wherein said second predefined transform is a three-dimensional discrete cosine transform.

9. Device for generating a saliency map for a picture of a sequence of pictures, said picture being divided in blocks of pixels, comprising a unit for computing a saliency value for each block of said picture wherein saliency value equals the self information of said block, said self information depending on the spatial and temporal contexts of said block.

10. A computer program product comprising a computer useable medium having computer readable program code embodied thereon, the computer program product comprising:
